(19) United States
(12) Patent Application Publication
(10) Pub. No.: US 2015/0347337 A1
(43) Pub. Date: Dec. 3, 2015

(54) Electronic Apparatus and Device Control Method

(71) Applicant: NEC DISPLAY SOLUTIONS, LTD., Minato-ku, Tokyo (JP)

(72) Inventor: Hiroshi SUNAGARE, Tokyo (JP)

(21) Appl. No.: 14/435,708

(22) PCT Filed: Nov. 2, 2012
(86) PCT No.: PCT/JP2012/078442

§ 371 Date: Apr. 14, 2015

(51) Int. Cl. G06F 13/40; G06F 13/42

(52) U.S. Cl. CPC G06F 13/4027; G06F 13/4221

(57) ABSTRACT

An electronic apparatus includes a holding unit that holds state information that indicates the interface that is set in a first device. If use of the interface that is set in a second device should be terminated, the second device sets itself to the interface that is indicated by the state information that is held in the holding unit.

### TECHNICAL FIELD

The present invention relates to an electronic apparatus equipped with a device that communicates in accordance with an interface.

### BACKGROUND ART

An electronic apparatus such as a projector or monitor is normally provided with various devices such as a CPU (Central Processing Unit) or memory, and the functions of the electronic apparatus are realized by communication between each device and other devices.

An interface (hereinbelow abbreviated as “IF”) for performing communication is set in each device provided in an electronic apparatus, and communication is possible only between devices that are set to the same IF.

For example, if a CPU carries out communication by designating a memory address to memory to transmit information, the memory transmits to the CPU information that corresponds to the memory address that was designated.

Formerly, only one IF could be set in this type of device, but in recent years, devices have been developed that are compatible with a plurality of IF and that are set to any among this plurality of IF.

For example, a SPI (Serial Peripheral Interface) flash ROM (Read Only Memory), which is one type of memory, is compatible with two IF having different addressing modes for designating memory addresses. More specifically, a SPI flash ROM is compatible with two IF: IF1 that corresponds to 3-Byte Address Mode that designates a memory address in three-byte units and IF2 that corresponds to a 4-Byte Address Mode that designates a memory address in four-byte units. A maximum of 16 M-Bytes of memory addresses can be designated in IF1, and a maximum of 4 G-Bytes of memory addresses can be designated in IF2. HW detection terminal

FIG. 1 is a sequence chart for describing the operation of an electronic apparatus that is provided with a device that is compatible with a plurality of IF. The electronic apparatus is assumed to be provided with a CPU and memory (SPI flash ROM) as the devices in FIG. 1.

The CPU and memory are first initialized (HW. Reset: Hardware Reset) when the electronic apparatus is activated (Power ON) and electric power is supplied to the CPU and memory, and IF1, that is the predetermined initial IF, is set as the IF to use in both the CPU and memory. In this way, the CPU and memory are able to use IF1 to communicate with each other, the CPU is able to use IF1 to read a program from the memory, and the CPU is able to operate in accordance with the program that was read.

The CPU then, at a predetermined timing, both uses IF1 to supply to the memory a switch instruction indicating that the IF to use in the memory is to be switched from IF1 to IF2, and further, switches the IF is to be used by the CPU in the CPU itself from IF1 to IF2. The memory, upon receiving the switch instruction, switches the IF that is to be used as the interface of memory itself from IF1 to IF2. In this way, the CPU and the memory are both set to IF2 and are able to carry out communication that uses IF2 between the CPU and the memory.

Some electronic apparatuses have a Watchdog function for initializing a specific device. This Watchdog function executes initialization (SW•Rest: Software Reset) of a specific device such as the CPU when the specific device runs out of control (for example, refer to Patent Document 1).

### LITERATURE OF THE PRIOR ART

### Patent Documents

Patent Document 1: Japanese Unexamined Patent Application Publication No. 2011-221287

### SUMMARY OF THE INVENTION

### Problem to be Solved by the Invention

In an electronic apparatus that uses devices that are compatible with a plurality of IF, the problem arises that when a specific device is initialized by the Watchdog function, communication is disabled between the device that was initialized and a device that has not been initialized, and it becomes impossible to restart the electronic apparatus.

FIG. 2 is a view for describing the above-described problem concretely and shows the operation when the Watchdog function is executed in an electronic apparatus that uses devices that are compatible with a plurality of IF. In FIG. 2, as in FIG. 1, the electronic apparatus is provided with a CPU and memory (SPI flash ROM) as devices. In addition, the device that is initialized by the Watchdog function is assumed to be the CPU.

The CPU is assumed to have run out of control and is initialized by the Watchdog function when IF2 is set as the IF to be used in the CPU and the memory. In this case, the IF that has been set for use in the CPU is switched from IF2 to IF1 which is the initial IF, but because initialization is not carried out for the memory, the IF in use in the memory remains IF2. As a result, the IF that is being used in the CPU is different from the IF that is being used in the memory and therefore the CPU and memory cannot communicate with each other. As a result, the CPU cannot communicate with the memory, and the electronic apparatus is incapable of restarting.

The present invention was realized to address of this problem, and has as an object the provision of an electronic apparatus and device control method capable of solving the problem in which, when devices that are compatible with a plurality of IF are used and when a specific device is initialized, the device that has been initialized becomes unable to communicate with a device that has not been initialized.

### Means for Solving the Problem

The electronic apparatus according to the present invention includes: a first device and a second device in which interfaces are set for realizing communication and that are able to communicate with each other when set to the same interface; and a holding unit that holds state information that indicates the interface that is set in the first device; wherein the second device, when the interface that is set in its own device is terminated, sets the interface that is indicated by the state information in its own device.

The device control method according to the present invention is a device control method realized by an electronic apparatus that has a first device and a second device in which interfaces are set for realizing communication and that are able to communicate with each other when set to the same interface, the device control method including steps of: holding state information that indicates the interface that is set in the first device; and when the interface that is set in the second device is terminated, setting the interface indicated by the state information in the second device.

### Effect of the Invention

According to the present invention, when devices are being used that are compatible with a plurality of IF and when a specific device is initialized, communication is possible between the device that has been initialized and a device that has not been initialized.

### BRIEF DESCRIPTION OF THE DRAWINGS

FIG. 1 is a sequence chart for describing the operation of an electronic apparatus of the related art.

FIG. 2 is a view for describing a problem of the electronic apparatus of the related art.

FIG. 3 shows the configuration of the electronic apparatus of the first exemplary embodiment of the present invention.

FIG. 4 shows an example of the configuration of the state holding unit.

FIG. 5 is a view for describing an example of the operation of the electronic apparatus of the first exemplary embodiment of the present invention.

FIG. 6 is a view for describing another example of the operation of the electronic apparatus of the first exemplary embodiment of the present invention.

FIG. 7 is a view for describing the characteristics of the state holding unit.

FIG. 8 is a view showing the configuration of the electronic apparatus of the second exemplary embodiment of the present invention.

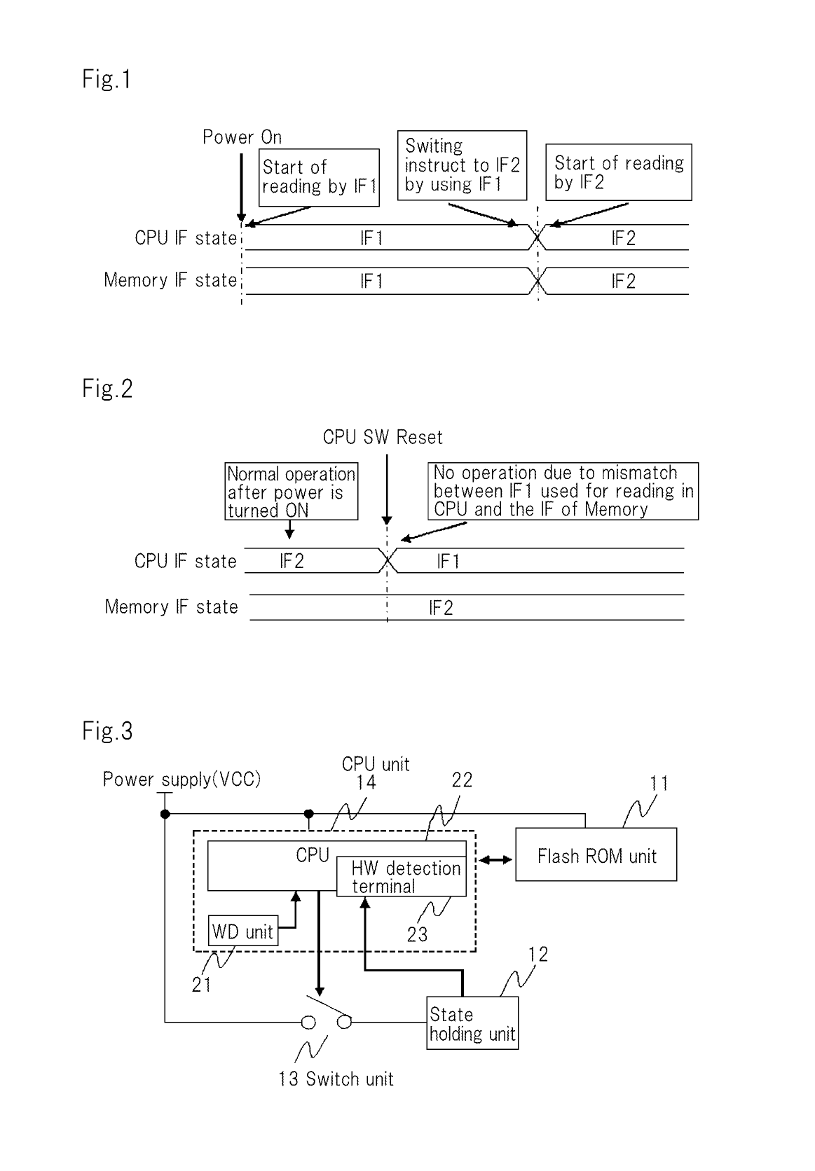

### BEST MODE FOR CARRYING OUT THE INVENTION

Exemplary embodiments of the present invention are next described with reference to the accompanying drawings. In the following explanation, components having the same function are given the same reference number, and redundant explanation of such components may be omitted.

FIG. 3 shows the configuration of the electronic apparatus of the first exemplary embodiment of the present invention. An example of the electronic apparatus that can be provided is an image display device such as a projector or monitor.

In FIG. 3, the electronic apparatus includes: flash ROM unit 11, state holding unit 12, switch unit 13, and CPU unit 14. CPU unit 14 includes Watchdog (WD) unit 21 and CPU 22. Flash ROM unit 11 and CPU unit 14 are connected to power supply VCC and operate on the electric power from power supply VCC.

Flash ROM unit 11 is one example of the first device and is a recording device (memory) that records various data such as programs that prescribe the operation of CPU 22.

Flash ROM unit 11 is compatible with a plurality of IF, which are IF for communicating with other devices, and from among this plurality of IF, uses the IF that has been set to communicate with CPU 22.

In the present exemplary embodiment, flash ROM unit 11 is assumed to be a SPI flash ROM that is compatible with IF1 that corresponds to the three-byte address mode in which memory addresses are designated in three-byte units and IF2 that corresponds to the four-byte address mode in which memory addresses are designated in four-byte units.

The region designated in the three-byte address mode is assumed to correspond to, from among the regions designated in the four-byte address mode, the region that is designated by the remaining three bytes when the most significant byte is 0x00. However, the region designated by the three-byte address mode and the region designated by the four-byte address mode may be configured as separate regions.

More specifically, an IF is a software interface that determines the communication rules for communicating with another device. Here, the software interface also includes information indicating the terminals that are used in communication. For example, serial communication and parallel communication are used in communication between flash ROM unit 11 and CPU 22. Parallel communication includes a case of using a 32-pin address terminal, a plurality of data terminals, and one address designation pin in the connection terminals that connect flash ROM unit 11 and CPU 22. In this case, communication is carried out using 3×8=24 address terminals in the case of three-byte address mode, and communication is carried out using 4×8=32 address terminals in the case of four-byte address mode.

At the time of activation, IF1, which is predetermined initial IF, is set in flash ROM unit 11 by flash ROM unit 11 itself. Flash ROM unit 11 then, upon receiving a switch instruction from CPU 22 indicating that the IF that is being used is to be switched, switches the IF that is being used in accordance with the switch instruction.

State holding unit 12 holds state information indicating the IF that was set for use in flash ROM unit 11 and supplies the state information that is held to CPU unit 14. In the present exemplary embodiment, the state information is 1-bit information, and indicates IF1 that is the initial IF when the voltage level is the L level and IF2 when the voltage level is the H level. State holding unit 12 is made up of, for example, a CR charge/discharge circuit.

Switch unit 13 switches between connection and disconnection of power supply VCC and state holding unit 12 by ON/OFF switching that accords with a switch control signal from CPU 14. More specifically, switch unit 13 connects power supply VCC and state holding unit 12 when turned ON and disconnects power supply VCC and state holding unit 12 when turned OFF.

In the present exemplary embodiment, the switch control signal is a 1-bit signal, and switch unit 13 turns ON when the switch control signal is H level and turns OFF when the switch control signal is L level.

In this case, electric power is supplied to state holding unit 12 when the switch control signal is H level, and the state information that is held in state holding unit 12 becomes the H level that indicates IF2. On the other hand, electric power to state holding unit 12 is disconnected when the switch control signal is the L level, and the state information that is held in state holding unit 12 becomes the L level that indicates IF1.

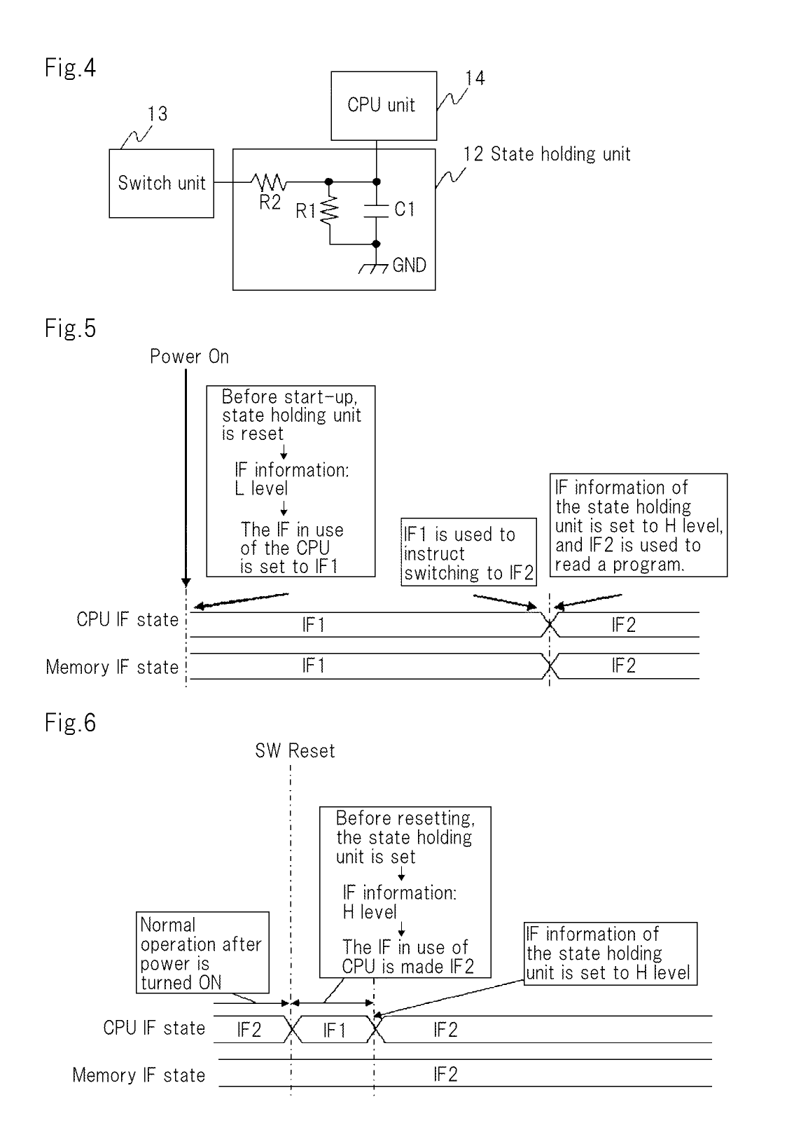

As an example, a case is next described in which state holding unit 12 is made up of the CR charge/discharge circuit shown in FIG. 4.

In state holding unit 12 shown in FIG. 4, capacitor C1 is charged by way of resistor R2 from power supply VCC when switch unit 13 turns ON.

Resistor R2 is a resistor that determines the charging current that is supplied to capacitor C1, and its resistance is set according to the capacitance of capacitor C1 such that overcurrent does not flow to capacitor C1. However, because charging from power supply VCC to capacitor C1 is preferably performed rapidly, the resistance of resistor R2 is set to a value no greater than 100Ω. The time constant when charging capacitor C1 can be adjusted according to the resistance of resistor R2.

Resistor R1 is a resistor for discharging the charge that has been charged in capacitor C1 when switch unit 13 is turned OFF, and its resistance is set from the time constant that is determined according to capacitor C1 and resistor R1. More specifically, the time constant that is determined according to capacitor C1 and resistor R1 is set such that the output voltage of state holding unit 12 does not fall below a judgment reference voltage (to be described) in the time interval from the resetting of CPU unit 14 until CPU unit 14 begins control of switch unit 13 that accords with the state information that is held in state holding unit 12. However, the time constant must be set to a suitable value because, if the time constant that is determined according to capacitor C1 and resistor R1 is too long, when power to the electronic apparatus is next turned ON after having been turned OFF, the output voltage of state holding unit 12 will be higher than the judgment reference voltage and will cause malfunctioning. Essentially, the electronic apparatus is preferably configured such that, when power is next turned ON after having been turned OFF, the output voltage of the state holding unit is a lower voltage than the judgment reference voltage, or preferably, is initialized.

In the case of the CR charge/discharge circuit shown in FIG. 4, the value of the state information becomes a voltage lower than VCC due to the values of resistors R1 and R2, but here, for the sake of convenience, the value of the state information is considered to be the same voltage as VCC because the resistance of resistor R2 is preferably sufficiently lower than that of the resistance of resistor R1.

Watchdog unit 21 that is referred to as a Watchdog timer, monitors CPU 22, and when CPU 22 does not respond for a fixed time interval because, for example, CPU 22 has run out of control, Watchdog unit 21 detects this state and supplies a reset signal to CPU 22.

CPU 22 is one example of the second device, and is a control device that controls each part of the electronic apparatus. CPU 22 includes a control port (not shown in the figures) that is the terminal that supplies the switch control signal and HW detection terminal 23 that receives state information from state holding unit 12.

CPU 22 is compatible with a plurality of IF that are being used, and from among the plurality of IF that are being used, is compatible with IF that has been set to communicate with flash ROM unit 11. Flash ROM unit 11 and CPU 22 are able to communicate with each other when set to the same IF.

In the present exemplary embodiment, CPU 22 is assumed to be compatible with the same two IF (IF1 and IF2) as flash ROM unit 11.

When a reset signal is supplied from Watchdog unit 21, CPU 22 carries out initialization (SW•Reset) of CPU 22 itself and terminates using the IF that has been set in CPU 22 itself.

When use of the IF is terminated, and when the electronic apparatus is activated, IF1, that is the predetermined initial IF, is set in CPU 22 itself by CPU 22. CPU 22 then detects the state information received by HW detection terminal 23 and sets the IF for use in CPU 22 itself that is indicated by the state information that was detected. CPU 22 then, by supplying a switch control signal that accords with the IF that was set from its control port to switch unit 13, changes the ON/OFF of switch unit 13 and causes the state information that indicates the IF that has been set to be held in state holding unit 12.

CPU 22 further switches the IF that is set for use in CPU 22 itself to another IF that is a different IF at a predetermined switch timing. At this time, CPU 22 supplies to flash ROM unit 11 a switch instruction to flash ROM unit 11 that indicates that the IF for use in flash ROM unit 11 that is being used is to be switched to the other IF. CPU 22 then supplies a switch control signal that accords with the other IF from its control port to switch unit 13 to switch the ON/OFF of switch unit 13 and cause the state information that indicates the other IF to be held in state holding unit 12.

In this way, CPU 22 both switches the IF being used and that is set in CPU 22 and flash ROM unit 11 to another IF at a predetermined switch timing and changes the IF indicated by the state information that is held in state holding unit 12 to the other IF.

The operation is next described.

FIG. 5 is a sequence chart for describing an example of the operation of the electronic apparatus at the time of activation.

In the state that precedes activation of the electronic apparatus, the switch control signal is the L level, and as a result, state holding unit 12 is assumed to have been reset (the state information is at ground voltage GND). As a result, state holding unit 12 holds state information of the L level that indicates that IF1 is the initial IF.

When the electronic apparatus is activated (the power is turned ON), power supply VCC turns ON and electric power is supplied to flash ROM unit 11 and CPU 22. Flash ROM unit 11 and CPU 22 are then initialized (HW•Reset), following which flash ROM unit 11 and CPU 22 start up.

At this time, flash ROM unit 11 sets in itself IF1 that is the predetermined initial IF, as the IF that is to be used.

In addition, CPU 22 sets IF1 that is the predetermined initial IF, as the IF that is to be used.

CPU 22 next uses HW detection terminal 23 to receive state information from state holding unit 12, checks the voltage level of the state information that was received, detects the IF that is being used by flash ROM unit 11 and sets for use in CPU 22 itself the IF that was detected.

Because the state information held by state holding unit 12 has here been reset to the L level, the state information indicates IF1, and IF1 that is the IF for use by flash ROM unit 11 is also set in CPU 21. As a result, CPU 22 and flash ROM unit 11 enter a state that allows devices that use IF1, to communicate with each other.

If the reception of state information that uses HW detection terminal 23 is possible before the setting of the initial IF, CPU 22 may set the IF based on the state of the state information without setting the initial IF.

CPU 22 then uses IF1 to communicate with flash ROM unit 11, to read programs from flash ROM unit 11, and to execute the programs to operate.

In addition, at a predetermined switch timing, CPU 22 uses IF1 to supply to flash ROM unit 11 a switch instruction to switch the IF being used to IF2. Flash ROM unit 11, upon receiving the switch instruction, switches the IF in use of flash ROM unit 11 itself to IF2.

Then, upon supplying the switch instruction, CPU 22 switches the IF in use of CPU 22 itself to IF2, and further, supplies from the control port to switch unit 13 a switch control signal of the H level. Upon receiving this switch control signal, switch unit 13 turns ON and connects state holding unit 12 and power supply VCC, whereby state holding unit 12 holds state information of the H level that indicates IF2.

CPU 22 subsequently uses IF2 to communicate with flash ROM unit 11, to read programs from flash ROM unit 11, and to execute the programs to operate.

The predetermined switch timing is, for example, a timing at which the necessity arises for designating memory addresses larger than the 16 M-bytes that is the maximum size of memory addresses that can be designated in IF1. For example, CPU 22 uses IF1 to read a program for booting, and after executing this program and activating the electronic apparatus, reads a program for basic operation, executes the program and operates. Subsequently, CPU 22 switches to IF2, reads a program that designates memory addresses that contain memory addresses greater than 16 M-bytes, and executes that program. The program for booting up and the program for basic operation are prepared such that the memory addresses necessary for these programs do not exceed 16 M-bytes.

FIG. 6 is a sequence chart for describing an example of the operation of the electronic apparatus when Watchdog unit 21 supplies a reset signal.

When CPU 22, for example, runs out of control and does not respond for a fixed time interval, Watchdog unit 21 supplies a reset signal to CPU 22. In the following explanation, it will be assumed that IF2 has been set as the IF for use in both flash ROM unit 11 and CPU 22, and state holding unit 12 holds state information of the H level.

CPU 22, having received the reset signal, initializes CPU 22 itself (SW•Reset) and terminates using the IF that was set in CPU 22 itself.

CPU 22 then sets to CPU 22 itself as the IF in use IF1 that is the predetermined initial IF. At this time, no communication is carried out with flash ROM unit 11. CPU 22 next uses HW detection terminal 23 to receive state information from state holding unit 12, checks the voltage level of the state information that was received to detect the IF in use of flash ROM unit 11, and sets the detected IF in use to CPU 22 itself.

At this time, the state information is the H level, and CPU 22 therefore detects IF2 as the IF in use of flash ROM unit 11 and sets IF2 as the IF in use in CPU 22 itself.

In this way, the IF in use of CPU 22 and flash ROM unit 11 match as IF2, and CPU 22 therefore becomes able to use IF2 to read all of the programs from flash ROM unit 11, read the necessary programs, execute the programs that were read, and operate.

When CPU 22 is initialized, the switch control signal is the L level, and switch unit 13 therefore is OFF. As a result, when CPU 22 as the IF that is to be used, CPU 22 also makes the switch control signal the H level, turns ON switch unit 13, and causes state holding unit 12 to hold state information that indicates IF2.

In addition, if it is assumed that a reset signal is supplied before CPU 22 switches the IF that is being used to IF2 at the time of activation, state holding unit 12 holds state information of the L level that indicates IF1, whereby CPU 22 carries out operation similar to the operation at the time of activation shown in FIG. 5.

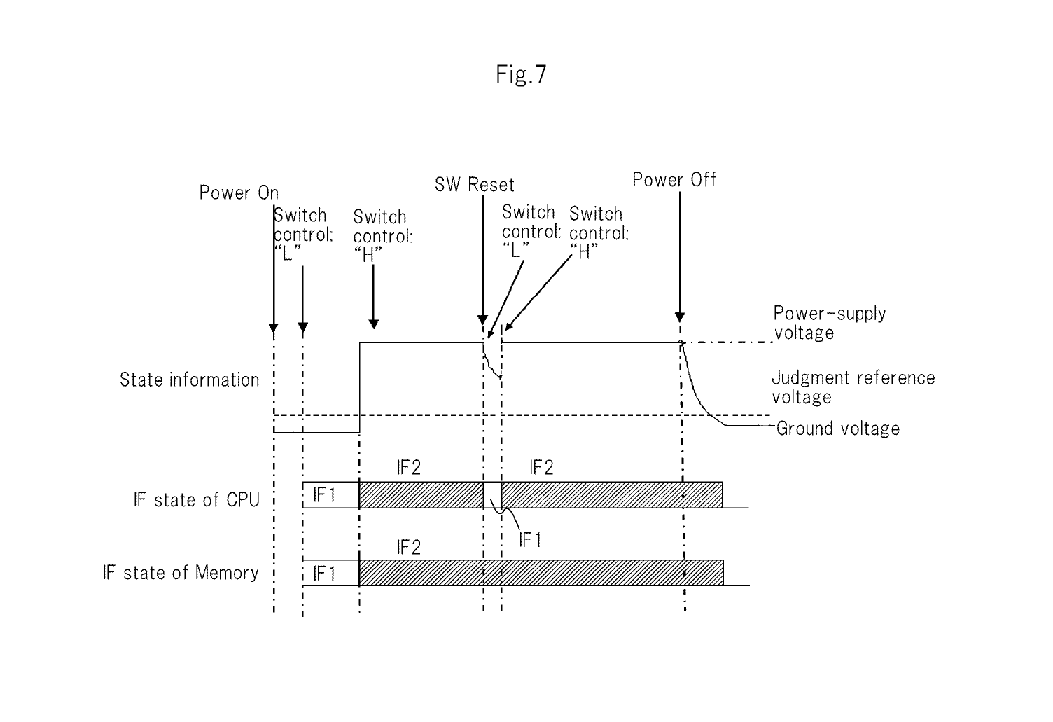

FIG. 7 is a view for describing the characteristics of state holding unit 12 and the transition of the IF for use in CPU 22 and flash ROM unit 11.

State holding unit 12 is assumed to be the CR charge/discharge circuit shown in FIG. 4. In addition, the time constant of setting state holding unit 12 (state information becomes power-supply voltage VCC) by the change of the switch control signal to the H level is assumed to be on the order of several ms, and the time constant of turning OFF switch unit 13 and resetting state holding unit 12 (state information becomes the ground voltage GND) is assumed to be on the order of 100 ms.

The judgment reference voltage shown by the broken line in FIG. 7 is a threshold value by which CPU 22 judges the level of the state information and is set in advance between power-supply voltage VCC and the ground voltage GND. CPU 22 determines the H level when the voltage of the state information of state holding unit 12 is equal to or greater than the judgment reference voltage, and determines the L level when the voltage of the state information is lower than the judgment reference voltage.

First, state holding unit 12 is reset before activation of the electronic apparatus. Then, when the electronic apparatus is activated, because the IF that is used by CPU 22 and flash ROM unit 11 is IF1 and the switch control signal remains unchanged at the L level, the state information becomes the L level. Subsequently, at a switch timing, the switch control signal becomes the H level and switch unit 13 turns ON, whereby the state information becomes the power-supply voltage, i.e., the H level.

When a reset signal is supplied from Watchdog unit 21 and CPU 22 is initialized (SW•Reset) in this state, the switch control signal becomes the L level, but before the state information of state holding unit 12 becomes lower than the reference voltage, CPU unit 14 detects the state of the state holding unit and a switch control signal that accords with the detected state is supplied, whereby IF2 is set in CPU 22 before CPU 22 begins communication.

According to the present exemplary embodiment as described hereinabove, when use of the IF that is set in CPU 22 is terminated, the IF for use in flash ROM unit 11 that is indicated by the state information that is held in state holding unit 12 is set in CPU 22 and, as a result, the IF that is set for use in CPU 22 and flash ROM unit 11 can be made to match even if CPU 22 is initialized. Accordingly, even if CPU 22 is initialized, CPU 22 is able to communicate with another device that has not been initialized and can be re-activated.

In addition, although state holding unit 12 took the form of a CR charge/discharge circuit in the present exemplary embodiment, state holding unit 12 may also be constituted by a digital circuit such as a flip-flop circuit. However, state holding unit 12 is configured to hold the state of the IF of devices that have not been reset when only a specific device has been reset, and to initialize the state of the IF when all devices have been reset, such as when power to the electronic apparatus is turned OFF.

Further, although state holding unit 12 was connected with a power-supply terminal by way of switch unit 13 in the present exemplary embodiment, when the output current of the control port of CPU 22 is sufficient for a current that charges state holding unit 12, a configuration may be adopted in which the control port of CPU 22 is connected to state holding unit 12 and an H or L signal is supplied. In this case, switch unit 13 may be deleted.

Thus, in the present exemplary embodiment, change to the IF that is indicated by state information is possible using a CR charge/discharge circuit or a digital circuit such as a flip-flop as state holding unit 12, and further, a circuit that is inexpensive and that takes up little substrate area can be used to realize communication with another device and enable restarting.

Still further, in the present exemplary embodiment, although CPU 22 carried out initialization (SW•Rest) of CPU 22 itself after having received a reset signal, the initialization is not limited to a SW•Reset and may be a HW•Reset. For example, in FIG. 3, flash ROM unit 11 and state holding unit 12 are connected to the same power supply VCC1 and CPU unit 14 is connected to a different power supply VCC2. Watchdog unit 21 may supply a reset signal in accordance with the state of CPU 22, and in accordance with the reset signal that was supplied, power supply VCC2 to which CPU unit 14 is connected may once be turned OFF and then again turned ON to initialize (HW•Reset) CPU unit 14. Connection to power supply VCC2 may be only for CPU 22. Alternatively, when the power supply of CPU unit 14 or CPU 22 is turned OFF, the state of the other power supply is ON, and care must therefore be exercised to prevent the occurrence of a reverse current.

The second exemplary embodiment is next described.

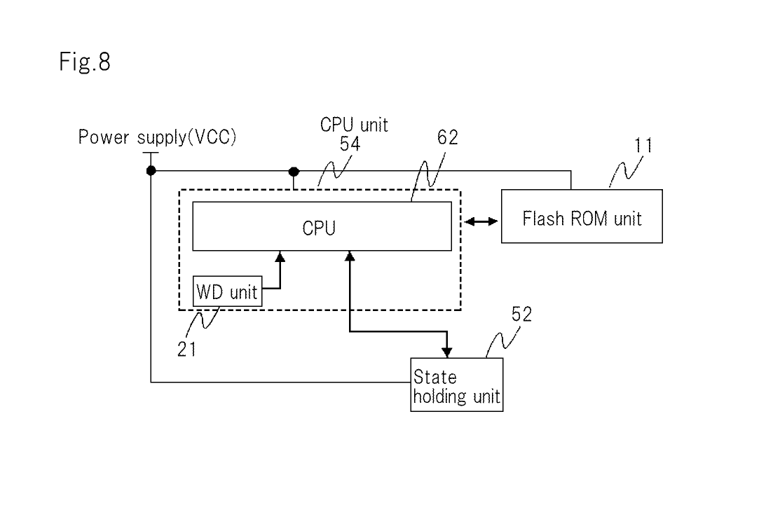

FIG. 8 shows the configuration of the electronic apparatus of the second exemplary embodiment of the present invention. As in the first exemplary embodiment, an image display device such as a projector or a monitor can be offered as an example of the electronic apparatus.

In FIG. 8, the electronic apparatus has flash ROM unit 11, state holding unit 52, and CPU unit 54. In addition, CPU unit 54 has Watchdog unit 21 and CPU 62. Flash ROM unit 11, state holding unit 52, and CPU unit 54 are connected to power supply VCC and operate on the electric power of power supply VCC.

State holding unit 52 is a memory circuit that holds state information that indicates the IF that was set for use in flash ROM unit 11. This memory circuit differs from flash ROM unit 11 and is not compatible with a plurality of IF and uses a specific predetermined IF to carry out communication. Examples that can be offered as this memory circuit include SRAM (Static Random Access Memory) and EEPROM (Electrically Erasable Programmable Read-Only Memory).

CPU 62 is one example of the second device, and as with CPU 22 shown in FIG. 3 of the first exemplary embodiment, when use of the IF that was set for use in CPU 62 is terminated, the IF indicated by the state information that is held in state holding unit 52 is set to CPU 62 as the IF that is to be used.

Of the configuration and functions executed by CPU 62, explanation will focus on configuration and functions that differ from those of CPU 22.

Compared to CPU 22, CPU 62 lacks HW detection terminal 23, but in its place, includes a hardware circuit (not shown in the figure) that, when the IF in use is terminated or the electronic apparatus is activated, reads state information that is held in state holding unit 52 and sets the IF, that is indicated by the state information that was read, for use in CPU 62 itself.

In addition, at a predetermined switch timing, CPU 62 switches the IF that was set for in both CPU 62 and flash ROM unit 11 to another IF and changes the state information that is held in state holding unit 52 to state information that indicates the other IF.

When power to the electronic apparatus is turned OFF, CPU 62 further carries out the initialization process that initializes the state information that is held in state holding unit 52 and then turns OFF the power to the electronic apparatus. When volatile memory such as SRAM is used as state holding unit 52, CPU 62 may omit the initialization process that initializes the state information held in state holding unit 52. The initial value of the state information is assumed to indicate IF1.

In the present exemplary embodiment as described hereinabove as well, as in the first exemplary embodiment, when use of the IF that is set in CPU 62 is terminated, the IF in use of flash ROM unit 11 that is indicated by the state information that is held in state holding unit 52 is set to CPU 62, and as a result, the IF in use that is set in each of CPU 62 and flash ROM unit 11 can be caused to match even when CPU 62 is initialized. Accordingly, even if CPU 62 is initialized, CPU 62 is able to communicate with other devices that have not been initialized and can therefore be restarted.

In each of the exemplary embodiments described hereinabove, the configurations shown in the figures are only examples, and the present invention is not limited to these configurations.

For example, Watchdog unit 21 was provided separately from CPU 22 or 62, but Watchdog unit 21 may also be incorporated in CPU 22 or 62.

Flash ROM unit 11 was used as the first device, and CPU 22 or 62 was used as the second device, but the first and second devices are not limited to these forms and can be modified as appropriate. For example, an external device such as memory can be applied as the first device instead of flash ROM unit 11.

In addition, although two IF, IF1 and IF2, were used as IF that are compatible with the first and second devices, the number of interfaces that are compatible with the first and second devices may be three or more. In this case, state holding unit 12 can be realized by circuits that hold information of a plurality of bits, such as a plurality of CR charge/discharge circuits. In addition, switch unit 13 can be realized by a plurality of switches that switch between connection and disconnection of power supply VCC and circuits that hold information of each bit.

### EXPLANATION OF REFERENCE NUMBERS

11 flash ROM unit
12, 52 state holding unit
13 switch unit
14, 54 CPU unit
21 Watchdog unit
22, 62 CPU
23 HW detection terminal

What is claimed is:

1. An electronic apparatus comprising:
a first device and a second device in which interfaces are set for realizing communication and that are able to communicate with each other when set to the same interface; and
a holding unit that holds state information that indicates an interface that is set in said first device;
wherein said second device, when use of the interface that is set in its own device is terminated, sets the interface that is indicated by said state information in its own device.

2. The electronic apparatus as set forth in claim 1, wherein at a predetermined timing said second device both switches the interface that is set in each of said first device and said second device to another interface and changes the interface indicated by said state information to said other interface.

3. The electronic apparatus as set forth in claim 1, wherein:
each of said first device and said second device sets a first interface as said interface in its own device at the time of activation; and
said second device, at a predetermined timing, both switches the interface that is set in both of said first device and said second device to a second interface that is said other interface and changes the interface indicated by said state information to said second interface.

4. The electronic apparatus as set forth in claim 3, wherein said state information indicates said first interface at times of L level and indicates said second interface at times of H level.

5. The electronic apparatus as set forth in claim 4, further comprising:
a switch unit that switches between connection and disconnection of a power supply and said holding unit;
wherein said second device uses said switch unit to change the interface indicated by said state information to said second interface.

6. The electronic apparatus as set forth in claim 1, wherein the electronic apparatus comprises a projector or a monitor.

7. A device control method that is realized by an electronic apparatus that has a first device and a second device in which interfaces are set for realizing communication and that are able to communicate with each other when set to the same interface, said device control method comprising:
holding state information that indicates the interface that is set in said first device; and
when use of the interface that is set in said second device is terminated, setting the interface indicated by said state information in said second device.
